(19) United States
(12) Patent Application Publication
(10) Pub. No.: US 2012/0121372 A1
(43) Pub. Date: May 17, 2012

(54) TOP UNLOADING TRAY DISPENSER

(76) Inventors: Glen F. Raque, Louisville, KY (US); Heath Burke, Louisville, KY (US)

(21) Appl. No.: 12/946,403

(22) Filed: Nov. 15, 2010

(51) Int. Cl. B65G 59/04; B65G 59/02

(52) U.S. Cl. 414/797; 414/796.5; 414/801

(57) ABSTRACT

A tray dispenser and method for removing trays from the top of a stack of trays. The tray dispenser includes a tray delivery system that positions the top tray in a tray removal position, and a tray removal system that removes the top tray, moves it and releases it in a tray release location. The tray dispenser can include a rotary arm to which the tray removal system is coupled. The rotary arm can move the removal system from a first position where it removes the tray from the removal location to a second position where it releases the tray in the release location. The removal system can include a suction cup assembly that holds the tray when it is removed and moved, then releases the tray in the release location. The tray dispenser can include a limit switch that senses when the tray is in the removal position.

### FIELD OF DISCLOSURE

The present disclosure relates generally to assembly line devices, and more particularly, to a tray dispenser that dispenses trays from the top of a stack of trays.

### BACKGROUND

Many assembly lines include tray dispensers that dispense trays for use on the assembly line, for example to hold items that are dispensed down line onto the trays. Tray dispensers typically take the trays from the bottom of a tray stack and place the trays on the assembly line. Some of these tray dispensing systems use screw systems with a knife edge to separate individual trays from the bottom of the stack and place them on the assembly. Other tray dispensers use vacuum suction with a flexible holdback device to remove a tray from the bottom of the tray stack and place the tray on the assembly line. For these types of tray dispensing devices, it is important to control the gap between the trays and to control the weight of the tray stack on the bottom tray. The weight of the tray stack is dependent on the number of trays in the tray stack which varies as trays are removed from the tray stack and as new trays are added to the tray stack. The gap between trays can also be affected by the number of trays in the tray stack. If the gap or the weight is not controlled, the bottom tray may not be removable by the device or multiple trays may be removed simultaneously by the device. Either condition is likely to require that the assembly line be stopped until the desired tray dispensing can be resumed.

It would be desirable to have a tray dispensing device that removes trays from the top of the tray stack that is not affected by the number of trays in the tray stack and that can minimize the stoppage of the assembly line due to the tray dispenser.

### SUMMARY

A first embodiment of a tray dispenser for removing trays from the top of a stack of trays and dispensing them in a tray release location is disclosed. The tray dispenser includes a tray delivery system and a tray removal system. The tray delivery system positions the top tray of the stack of trays in a tray removal position. The tray removal system removes the top tray of the stack of trays, then moves the top tray and releases it in the tray release location. The tray dispenser can also include a frame to which the tray delivery system and the tray removal system are coupled. The frame can include an inclined face and the tray delivery system can be coupled to the inclined face. The tray release location can be above a conveyor belt. The frame can include a tie bracket that couples the tray dispenser to the conveyor belt.

The tray delivery system can include a tray delivery motor, a tray drive mechanism advanced by the tray delivery motor; and a paddle coupled to the tray drive mechanism. The stack of trays can be placed on the paddle and the tray delivery motor can advance the tray drive mechanism and the paddle to position the top tray of the stack of trays in the tray removal position. The tray delivery system can also include a drive shaft coupling the tray delivery motor to the tray drive mechanism. The tray delivery system can also include a limit switch that senses when the top tray of the stack of trays is in the tray removal position, and sends a signal to stop advancement of the tray drive mechanism when the top tray is in the tray removal position. The limit switch can be an electric eye.

The tray dispenser can also include a rotary arm system coupled to the frame, and the tray removal system can be coupled to the rotary arm system. The rotary arm system can include a rotary arm motor, a distal shaft to which the tray removal system is coupled, and a first rotary arm having a proximal end and a distal end. The rotary arm motor can be coupled to the proximal end of the rotary arm, and the distal shaft can be coupled to the distal end of the rotary arm. The rotary arm motor can move the tray removal system from a first position where the tray removal system removes the top tray of the stack of trays to a second position where the tray removal system releases the top tray in the tray release location. The rotary arm system can also include a torque shaft coupled to the first rotary arm motor, and the proximal end of the first rotary arm can be coupled to the torque shaft. The rotary arm system can also include a second rotary arm having a proximal end and a distal end, the torque shaft can be coupled to proximal ends of the first and second rotary arms, the distal shaft can be coupled to the distal ends of the first and second rotary arms, and the tray removal system can be coupled to the distal shaft between the first and second rotary arms. The distal shaft of the rotary arm system can pivot the tray removal system as the tray removal system moves the top tray from the first position to the second position.

The tray removal system can include a suction cup assembly and a pressure system. The pressure system can create a low pressure region in the suction cup assembly when the tray removal system is in the first position so that the suction cup assembly can remove the top tray and hold the top tray until the tray removal system reaches the second position, then the pressure system can remove the low pressure region in the suction cup assembly when the tray removal system is in the second position so that the suction cup assembly releases the top tray in the tray release location.

An alternative embodiment of a tray dispenser for removing trays from the top of a stack of trays and dispensing them in a tray release location is disclosed. The tray dispenser includes a tray delivery system for positioning the top tray of the stack of trays in a tray removal position, a rotary arm system, and a tray removal system coupled to the rotary arm system, the tray removal system removing the top tray of the stack of trays from the tray removal position, moving the top tray and releasing the top tray in the tray release location. The tray removal system can include a suction cup assembly and a pressure system. The pressure system can create a low pressure region in the suction cup assembly when the tray removal system removes the top tray and moves the top tray to the tray release location, and then the pressure system can remove the low pressure region in the suction cup assembly when the tray removal system is in the tray release location to release the top tray. The tray delivery system can include a tray delivery motor, a tray drive mechanism advanced by the tray delivery motor, and a paddle coupled to the tray drive mechanism. The stack of trays can be placed on the paddle and the tray delivery motor can advance the tray drive mechanism and the paddle to position the top tray of the stack of trays in the tray removal position. The tray delivery system can include a limit switch that senses when the top tray of the stack of trays is in the tray removal position and sends a signal to stop advancement of the tray drive mechanism when the top tray is in the tray removal position. The rotary arm system can include a rotary arm motor, a torque shaft coupled to the rotary arm motor, a pivot shaft to which the tray removal system can be coupled, and a rotary arm having a proximal end and a distal end. The proximal end of the rotary arm can be coupled to the torque shaft and the distal end of the rotary arm can be coupled to the pivot shaft. The rotary arm motor can move the tray removal system from a first position where the tray removal system removes the top tray of the stack of trays to a second position where the tray removal system releases the top tray in the tray release location. The tray dispenser can include a frame to which the tray delivery system and the rotary arm are coupled. The frame can include a tie bracket that couples the tray dispenser to a conveyor belt and the tray release location can be above the conveyor belt.

Another embodiment of a tray dispenser for removing trays from the top of stacks of trays and dispensing them in tray release locations is disclosed that includes a frame, a plurality of tray delivery systems coupled to the frame, a rotary arm system coupled to the frame, and a plurality of tray removal systems coupled to the rotary arm system. Each of the plurality of tray delivery system positions a top tray of a stack of trays in a tray removal position. Each of the plurality of tray removal systems removes the top tray of the stack of trays of one of the plurality of tray delivery systems, moves the top tray and releases the top tray in the tray release location for the tray removal system. Each of the plurality of tray removal systems can include a suction cup assembly and a pressure system, where the pressure system creates a low pressure region in the suction cup assembly when the tray removal system removes the top tray from one of the plurality of tray delivery systems and moves the top tray to the tray release location, and then the pressure system removes the low pressure region in the suction cup assembly when the tray removal system is in the tray release location for the tray removal system and releases the top tray in the tray release location for the tray removal system. Each of the plurality of tray delivery systems can include a tray delivery motor, a tray drive mechanism advanced by the tray delivery motor, and a paddle coupled to the tray drive mechanism. The stack of trays can be placed on the paddle and the tray delivery motor can advance the tray drive mechanism and the paddle to position the top tray of the stack of trays in the tray removal position. Each of the plurality of tray delivery systems can include a limit switch that senses when the top tray is in the tray removal position and sends a signal to stop advancement of the tray drive mechanism when the top tray is in the tray removal position. The rotary arm system can include a rotary arm motor, a torque shaft coupled to the rotary arm motor, a pivot shaft to which the plurality of tray removal systems can be coupled, and a rotary arm having a proximal end and a distal end. The proximal end of the rotary arm can be coupled to the torque shaft and the distal end of the rotary arm can be coupled to the pivot shaft. The rotary arm motor can move the plurality of tray removal systems from a first position where each of the tray removal systems removes the top tray of the stack of trays to a second position where each of the tray removal systems releases the top tray in the tray release location for the tray removal system.

A method for removing trays from the top of a stack of trays and placing the tray in a release location is disclosed. The method includes positioning a top tray in a tray removal position using a tray delivery mechanism, removing the top tray from the tray removal position using a tray removal mechanism, moving the top tray from the tray removal position to the tray release location using the tray removal mechanism, releasing the top tray in the tray release location, returning the tray removal mechanism to the tray removal position, and repeating the process to remove the next tray of the stack of trays. The method can also include sensing the presence of a tray in the tray removal position; and waiting until a tray is sensed in the tray removal position before returning the tray removal mechanism to the tray removal position.

The tray delivery mechanism can include a tray delivery motor, a tray drive mechanism and a tray guide rail, and the stack of trays can be located on the tray drive mechanism. In this case, positioning a top tray of the stack of trays in the tray removal position can include using the tray delivery motor to advance the tray drive mechanism, advancing the stack of trays on the tray drive mechanism along the tray guide rail until the top tray of the stack of trays reaches the tray removal position, and ceasing advancement of the tray drive mechanism while the top tray of the stack of trays is in the tray removal position.

The tray removal mechanism can include a suction cup assembly and a pressure system. In this case, removing the top tray from the stack of trays can include generating a low pressure region in the suction cup assembly using the pressure system; and removing the top tray using the suction cup assembly; moving the top tray from the tray removal position to the tray release location can include moving the suction cup assembly while maintaining the low pressure region in the suction cup assembly; and releasing the top tray in the tray release location can include discontinuing the low pressure region in the suction cup assembly to release the tray from the suction cup assembly.

For a more complete understanding of the present disclosure, reference is now made to the following detailed description and the accompanying drawings.

### BRIEF DESCRIPTION OF THE DRAWINGS

FIG. 1 shows a front, left-side perspective view of an embodiment of a tray dispenser that dispense trays from the top of a tray stack;

FIG. 2 shows a front, right-side perspective view of the embodiment of the tray dispenser shown in FIG. 1;

FIG. 3 shows a rear, left-side perspective view of the embodiment of the tray dispenser shown in FIG. 1;

FIG. 4 shows a side view of the embodiment of the tray dispenser shown in FIG. 1; and

FIG. 5 shows the tray dispenser shown in FIG. 1 adjacent to an assembly line.

### DETAILED DESCRIPTION OF EXEMPLARY EMBODIMENTS

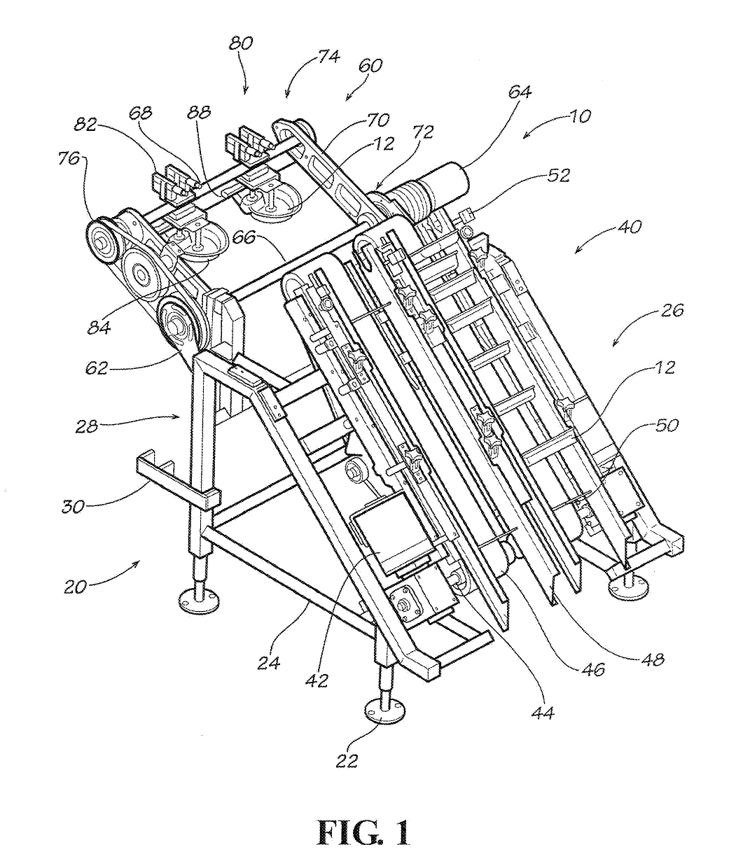

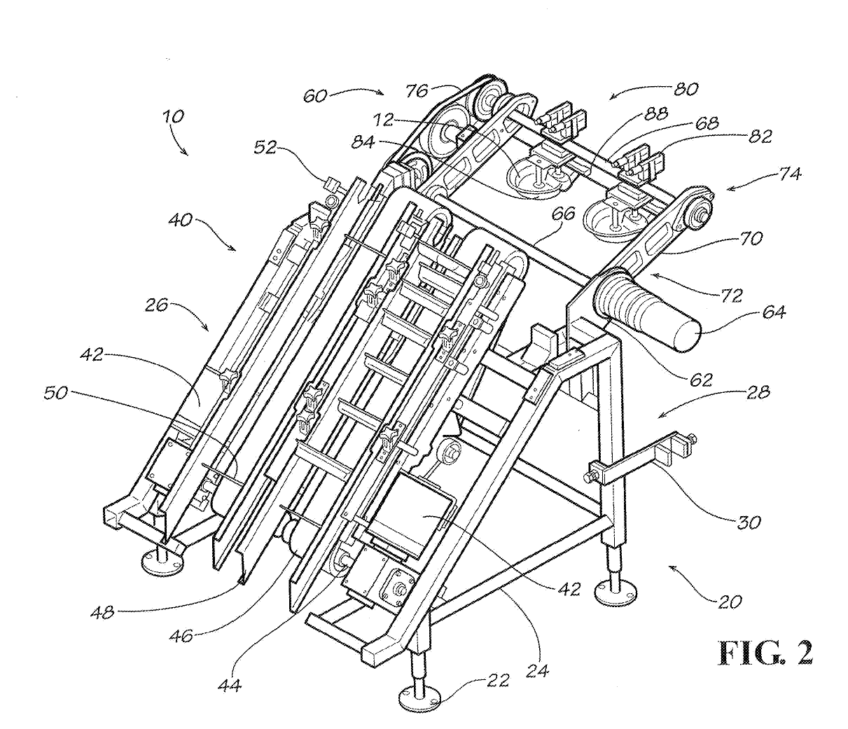

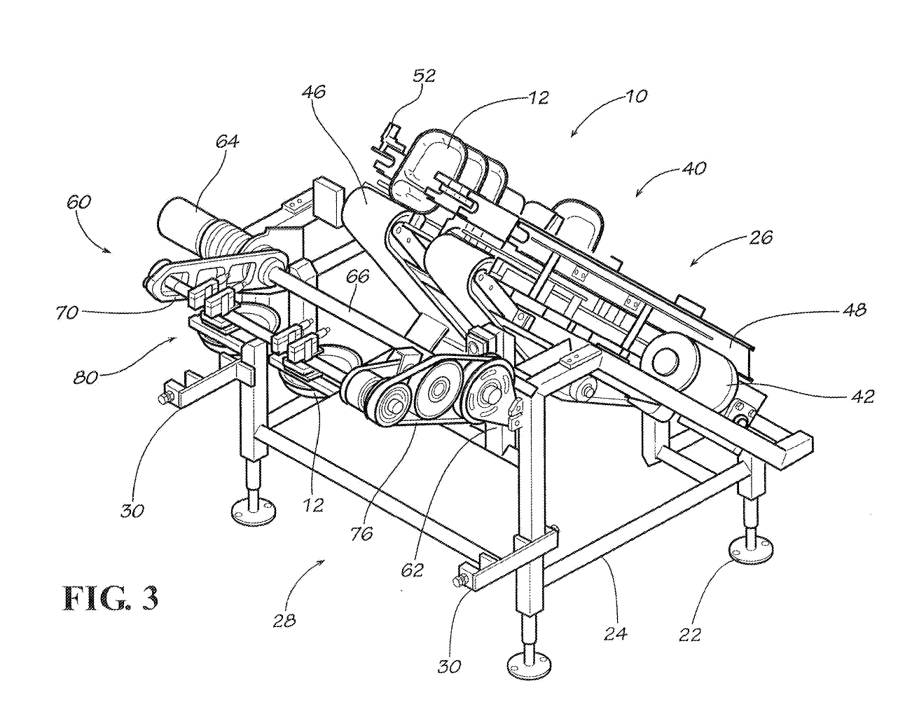

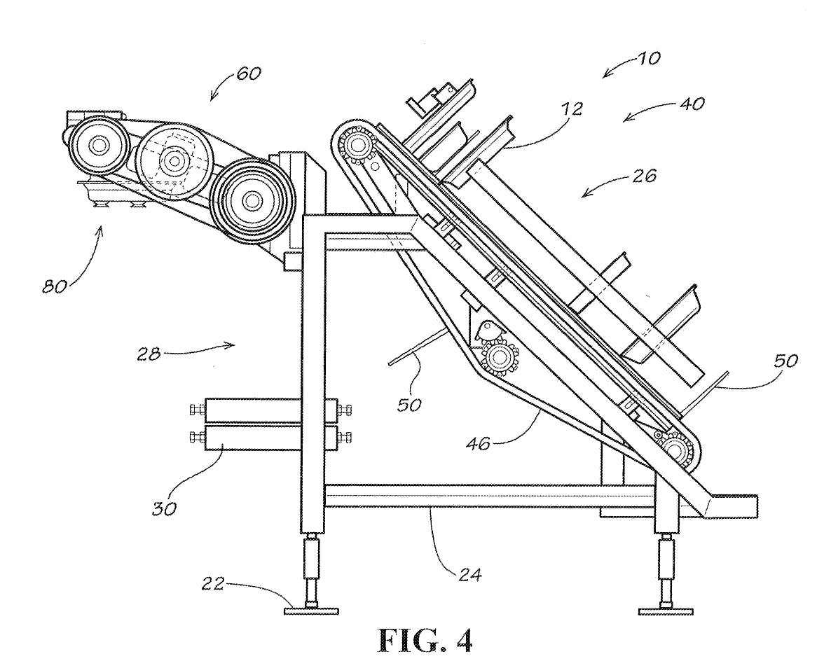

FIGS. 1-5 show an exemplary embodiment of a tray dispenser 10 that can be used to dispense trays 12 from the top of a tray stack onto an assembly line 100. In this embodiment, the tray dispenser 10 includes a frame 20, an uphill tray delivery system 40, a rotary arm system 60 and a tray removal system 80.

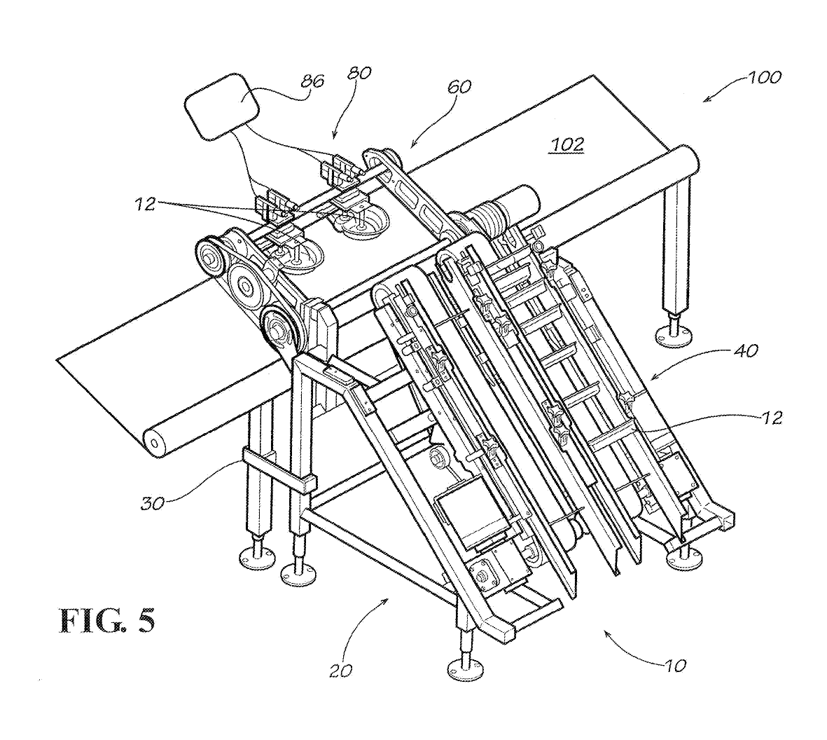

The frame 20 includes one or more feet 22 that are attachable to the floor or other stable surface and supporting members 24 for supporting the tray delivery system 40 and the rotary arm system 60. In the embodiment shown, the frame 20 includes an inclined, uphill face 26, a rear face 28 and at least one tie bracket 30. The tray delivery system 40 is coupled to the inclined face 26, and the rotary arm system 60 is coupled to the rear face 28. The rotary arm system 60 can be attached to another portion of the frame 20 if desired, for example a top face of the frame 20. The tie bracket 30 can be used to couple the tray dispenser 10 to an assembly line 100 as shown in FIG. 5.

The tray delivery system 40 includes a motor 42, a drive shaft 44, a tray drive mechanism 46, at least one tray guide rail 48 and at least one paddle 50. The motor 42 rotates the drive shaft 44 which advances the tray drive mechanism 46 along the tray guide rail 48. The at least one paddle 50 is coupled to the tray drive mechanism 46. The tray delivery system 40 can also include a limit switch 52 that stops advancement of the trays 12 beyond a tray removal position. The limit switch 52 can be and electric eye that views the top of the tray guide rail 48. The embodiment shown includes two tray delivery systems 40 coupled to the inclined face 26 of the frame 20. The tray dispenser 10 can include one or more tray delivery systems 40.

One or more trays 12 can be placed on the paddle 50. The motor 42 through the drive shaft 44 advances the tray drive mechanism 46 which moves the paddle 50. The trays 12 placed on the paddle 50 move along the tray guide rail 48 towards the top of the tray delivery system 40. When the top tray 12 of the one or more trays 12 placed on the paddle 50 is in position to be removed by the rotary arm system 60, the limit switch 52 sends a signal to stop the advancement of the tray drive mechanism 46 until the top tray 12 is removed by the tray removal system 80. The advancement of the tray drive mechanism 46 can be stopped in various ways known to those of skill in the art including, for example, stopping the motor 42 or disengaging the motor 42 from the drive shaft 44.

In the embodiment shown, the rotary arm system 60 includes a bracket 62, a motor 64, a torque shaft 66, a pivot shaft 68, at least one rotary arm 70 and a belt 76. Each of the at least one rotary arms 70 has a proximal end 72 and a distal end 74. The bracket 62 is coupled to the frame 20. The torque shaft 66 and the motor 64 are coupled to the bracket 62. The proximal end 72 of the rotary arm 70 is coupled to the torque shaft 66 and the distal end 74 of the rotary arm 70 is coupled to the pivot shaft 68. The tray removal system 80 is coupled to the pivot shaft 68. The belt 76 is coupled to the motor 64 and the belt 76 couples the torque shaft 66 to the pivot shaft 68.

The tray removal system 80 includes a mounting bracket 82 and a tray removal mechanism 84. In the embodiment shown, the tray removal mechanism 84 is a suction cup assembly. The mounting bracket 82 couples the tray removal mechanism 84 to the pivot shaft 68 of the rotary arm system 60. The suction cup assembly 84 is coupled to a pressure system 86 (shown in FIG. 5) that can generate a low pressure region in the suction cup for removing the tray 12 from the stack and holding the tray 12 during movement of the tray 12, and can generate an ambient pressure or high pressure region in the suction cup for releasing the tray 12 onto the conveyor belt 102 of the assembly line 100.

The motor 64 rotates the torque shaft 66; which rotates the rotary arm 70, the pivot shaft 72 and the tray removal system 80 around the longitudinal axis of the torque shaft 66 from a first position to a second position. The belt 76 pivots the pivot shaft 68 about its longitudinal axis between the first position and the second position. The tray removal mechanism 84 picks up a tray 12 in the first position and releases the tray 12 in the second position.

In the first position, the torque shaft 66 is rotated to position the tray removal system 80 above the top tray 12 on the paddle 50 of the tray delivery system 40, and the pivot shaft is pivoted to position the tray removal system 80 substantially parallel with the top tray 12. In this position, the pressure system 86 creates a low pressure region in the suction cup assembly 84 to remove the top tray 12 and hold it with the tray removal system 80.

While the tray removal system 80 is holding the tray 12, the torque shaft 66 is rotated to the second position. In the second position, the torque shaft 66 is rotated to position the tray removal system 80 above the conveyor belt 102 of the assembly line 100, and the pivot shaft is pivoted to position the tray removal system 80 substantially parallel with the conveyor belt 102. In this position, the pressure system 86 releases the low pressure region to restore ambient pressure or creates a slightly high pressure region in the suction cup assembly 84 to release the tray 12 onto the conveyor belt 102.

The tray dispenser 10 can include a tray sensor 88 that detects if there is already a tray or other impediment on the conveyor belt 102 in the area where the tray removal system 80 will release the next tray 12. If the tray sensor 88 detects that the conveyor belt 102 is clear in the area where the tray removal system 80 will release the next tray 12, then the tray removal system 80 can release the tray 12 onto the conveyor belt 102. But if the tray sensor 88 detects that the conveyor belt 102 is not clear in the area where the tray removal system 80 will release the next tray 12, then the tray removal system 80 can continue to hold the tray 12 until the conveyor belt 102 is clear.

The embodiment of the tray dispenser 10 shown in the figures includes one frame 20, two tray delivery systems 40, one rotary arm system 60 and two tray removal systems 80. Each of the tray delivery systems 40 is coupled to the inclined face 26 of the frame 20. Each of the tray removal mechanisms 80 is coupled to the pivot shaft 68 of the rotary arm system 60. The rotary arm system 60 is positioned relative to the tray delivery assemblies 40 so that each tray removal system 80 coupled to the pivot shaft 68 can remove a tray 12 from one of the tray delivery assemblies 40 and dispense the tray 12 in a tray release location for the tray removal system 80. The tray dispenser 10 can include one or more frames 20, tray delivery systems 40, rotary arm systems 60 and tray removal systems 80 for dispensing trays on multiple conveyors.

An exemplary method of using the tray dispenser 10 can include the following. The frame 20 is placed adjacent to the conveyor belt 102 of the assembly line system 100. The tie brackets 30 are coupled to the assembly line system 100 to maintain the relative position of the tray dispenser 10 to the conveyor belt 102.

One or more trays 12 are placed on the paddle 50 of the tray delivery system 40. The motor 42 of the tray delivery system 40 advances the tray drive mechanism 46 which advances the paddle 50 and the trays 12 along the tray guide rail 48 until the limit switch 52 senses that the top tray of the trays 12 on the paddle 50 has reached an upper limit position. When the limit switch 52 senses that the top tray 12 has reached the upper limit position, a signal is sent to stop advancing the tray drive mechanism 46 and to notify the rotary arm assembly 60 that a tray is ready to be removed.

When the rotary arm assembly 60 is notified that a tray 12 is ready to be removed, the motor 64 of the rotary arm assembly 60 rotates the torque shaft 66 and pivots the pivot shaft 68 to the tray removal position where the tray removal assembly 80 removes the top tray 12 on the paddle 50 of the tray delivery system 40. While the tray 12 is held by the tray removal assembly 80, the motor 64 of the rotary arm assembly 60 rotates the torque shaft 66 and pivots the pivot shaft 68 to move the tray removal assembly 80 to the tray release position.

If the tray detector 88 senses that the conveyor belt 102 is clear around the tray release location, the tray removal assembly 80 releases the tray 12 onto the conveyor belt 102 of the assembly line 100. If the tray detector 88 senses that there is an obstruction, for example another tray, at the tray release location, the tray removal assembly 80 holds the tray 12 until the tray release location is clear and then the tray removal assembly 80 releases the tray 12 onto the conveyor belt 102 of the assembly line 100. While the rotary arm system 60 is moving between the tray removal position and the tray release position, the tray delivery system 40 advances the paddle 50 so the next tray 12 on the paddle 50 or the top tray 12 of the next stack of trays on the tray delivery system 40 is in position to be removed by the tray removal system 80.

While exemplary embodiments incorporating the principles of the present invention have been disclosed hereinabove, the present invention is not limited to the disclosed embodiments. Instead, this application is intended to cover any variations, uses, or adaptations of the invention using its general principles. Further, this application is intended to cover such departures from the present disclosure as come within known or customary practice in the art to which this invention pertains and which fall within the limits of the appended claims.

I claim:

1. A tray dispenser for removing trays from the top of a stack of trays and dispensing them in a tray release location, the tray dispenser comprising:
a tray delivery system for positioning the top tray of the stack of trays in a tray removal position; and
a tray removal system for removing the top tray of the stack of trays from the tray removal position, moving the top tray to the tray release location, and releasing the top tray in the tray release location.

2. The tray dispenser of claim 1, further comprising a frame, the tray delivery system and the tray removal system being coupled to the frame.

3. The tray dispenser of claim 2, wherein the frame includes an inclined face and the tray delivery system is coupled to the inclined face.

4. The tray dispenser of claim 2, wherein the tray release location is above a conveyor belt.

5. The tray dispenser of claim 4, wherein the frame includes a tie bracket, the tie bracket coupling the tray dispenser to the conveyor belt.

6. The tray dispenser of claim 1, wherein the tray delivery system comprises:
a tray delivery motor;
a tray drive mechanism advanced by the tray delivery motor; and
a paddle coupled to the tray drive mechanism,
wherein the stack of trays is placed on the paddle and the tray delivery motor advances the tray drive mechanism and the paddle to position the top tray of the stack of trays in the tray removal position.

7. The tray dispenser of claim 6, wherein the tray delivery system further comprises a drive shaft coupling the tray delivery motor to the tray drive mechanism.

8. The tray dispenser of claim 6, wherein the tray delivery system further comprises a limit switch sensing when the top tray of the stack of trays is in the tray removal position and the limit switch sending a signal to stop advancement of the tray drive mechanism when the top tray of the stack of trays is in the tray removal position.

9. The tray dispenser of claim 8, wherein the limit switch is an electric eye.

10. The tray dispenser of claim 1, wherein the tray delivery system further comprises a limit switch sensing when the top tray of the stack of trays is in the tray removal position and the limit switch sending a signal to maintain the top tray of the stack of trays is in the tray removal position until the top tray is removed by the tray removal system.

11. The tray dispenser of claim 10, wherein the limit switch is an electric eye.

12. The tray dispenser of claim 1, further comprising a rotary arm system coupled to the frame, the tray removal system being coupled to the rotary arm system.

13. The tray dispenser of claim 12, wherein the rotary arm system comprises:
a rotary arm motor;
a distal shaft, the tray removal system being coupled to the distal shaft; and
a first rotary arm having a proximal end and a distal end, the rotary arm motor being coupled to the proximal end and the distal shaft being coupled to the distal end;
wherein the rotary arm motor moves the tray removal system from a first position where the tray removal system removes the top tray of the stack of trays from the tray removal position to a second position where the tray removal system releases the top tray in the tray release location.

14. The tray dispenser of claim 13, wherein the rotary arm system further comprises a torque shaft coupled to the first rotary arm motor and the proximal end of the first rotary arm being coupled to the torque shaft.

15. The tray dispenser of claim 14, wherein the rotary arm system further comprises a second rotary arm having a proximal end and a distal end, the torque shaft being coupled to proximal ends of the first and second rotary arms, the distal shaft being coupled to the distal ends of the first and second rotary arms, and the tray removal system being coupled to the distal shaft between the first and second rotary arms.

16. The tray dispenser of claim 14, wherein the distal shaft of the rotary arm system pivots the tray removal system as the tray removal system moves the top tray from the first position to the second position.

17. The tray dispenser of claim 16, wherein the tray removal system includes a suction cup assembly and a pressure system, the pressure system creating a low pressure region in the suction cup assembly when the tray removal system is in the first position, the suction cup assembly removing the top tray from the tray removal position and holding the top tray until the tray removal system reaches the second position, the pressure system removing the low pressure region in the suction cup assembly when the tray removal system is in the second position to release the top tray in the tray release location.

18. The tray dispenser of claim 1, wherein the tray removal system includes a suction cup assembly and a pressure system, the pressure system creating a low pressure region in the suction cup assembly when the tray removal system removes the top tray from the tray removal position, the suction cup assembly holding the top tray while the tray removal system moves the top tray to the tray release location, the pressure system removing the low pressure region in the suction cup assembly when the tray removal system is in the tray release location.

19. A tray dispenser for removing trays from the top of a stack of trays and dispensing them in a tray release location, the tray dispenser comprising:
a tray delivery system for positioning the top tray of the stack of trays in a tray removal position;
a rotary arm system; and
a tray removal system coupled to the rotary arm system, the tray removal system removing the top tray of the stack of trays, moving the top tray to the tray release location, and releasing the top tray in the tray release location.

20. The tray dispenser of claim 19, wherein the tray removal system comprises:
a suction cup assembly, and
a pressure system, the pressure system creating a low pressure region in the suction cup assembly when the tray removal system removes the top tray from the tray removal position, the suction cup assembly holding the top tray while the tray removal system moves the top tray to the tray release location, the pressure system removing the low pressure region in the suction cup assembly when the tray removal system is in the tray release location and releasing the top tray.

21. The tray dispenser of claim 20, wherein the tray delivery system comprises:
a tray delivery motor;
a tray drive mechanism advanced by the tray delivery motor; and
a paddle coupled to the tray drive mechanism,
wherein the stack of trays is placed on the paddle and the tray delivery motor advances the tray drive mechanism and the paddle to position the top tray of the stack of trays in the tray removal position.

22. The tray dispenser of claim 21, wherein the tray delivery system further comprises a limit switch sensing when the top tray of the stack of trays is in the tray removal position and the limit switch sending a signal to stop advancement of the tray drive mechanism when the top tray of the stack of trays is in the tray removal position.

23. The tray dispenser of claim 21, wherein the rotary arm system comprises:
a rotary arm motor;
a torque shaft coupled to the rotary arm motor;
a pivot shaft, the tray removal system being coupled to the pivot shaft; and
a rotary arm having a proximal end and a distal end, the proximal end being coupled to the torque shaft and the distal end being coupled to the pivot shaft;
wherein the rotary arm motor moves the tray removal system from a first position where the tray removal system removes the top tray of the stack of trays from the tray removal position to a second position where the tray removal system releases the top tray in the tray release location.

24. The tray dispenser of claim 23, further comprising a frame, the tray delivery system and the rotary arm system being coupled to the frame.

25. The tray dispenser of claim 24, wherein the frame includes a tie bracket, the tie bracket coupling the tray dispenser to a conveyor belt and the tray release location being above the conveyor belt.

26. A tray dispenser for removing trays from the top of stacks of trays and dispensing them in tray release locations, the tray dispenser comprising:
a frame;
a plurality of tray delivery systems coupled to the frame, each of the plurality of tray delivery system positioning a top tray of a stack of trays in a tray removal position;
a rotary arm system coupled to the frame; and
a plurality of tray removal systems coupled to the rotary arm system, each of the plurality of tray removal systems removing the top tray of the stack of trays of one of the plurality of tray delivery systems, moving the top tray and releasing the top tray in the tray release location for the tray removal system.

27. The tray dispenser of claim 26, wherein each of the plurality of tray removal systems comprises:
a suction cup assembly, and
a pressure system, the pressure system creating a low pressure region in the suction cup assembly when the tray removal system removes the top tray of the stack of trays of the one of the plurality of tray delivery systems from the tray removal position, the suction cup assembly holding the top tray while the tray removal system moves the top tray to the tray release location for the tray removal system, the pressure system removing the low pressure region in the suction cup assembly when the tray removal system is in the tray release location for the tray removal system and releasing the top tray in the tray release location for the tray removal system.

28. The tray dispenser of claim 26, wherein each of the plurality of tray delivery systems comprises:
a tray delivery motor;
a tray drive mechanism advanced by the tray delivery motor; and
a paddle coupled to the tray drive mechanism,
wherein the stack of trays is placed on the paddle and the tray delivery motor advances the tray drive mechanism and the paddle to position the top tray of the stack of trays in the tray removal position.

29. The tray dispenser of claim 28, wherein each of the plurality of tray delivery systems further comprises a limit switch sensing when the top tray of the stack of trays is in the tray removal position and the limit switch sending a signal to stop advancement of the tray drive mechanism when the top tray of the stack of trays is in the tray removal position.

30. The tray dispenser of claim 26, wherein the rotary arm system comprises:
a rotary arm motor;
a torque shaft coupled to the rotary arm motor;
a pivot shaft, the plurality of tray removal systems being coupled to the pivot shaft; and
a rotary arm having a proximal end and a distal end, the proximal end being coupled to the torque shaft and the distal end being coupled to the pivot shaft;
wherein the rotary arm motor moves the plurality of tray removal systems from a first position where each of the tray removal systems removes the top tray of the stack of trays from the tray removal position to a second position where each of the tray removal systems releases the top tray in the tray release location for the tray removal system.

31. A method for removing trays from the top of a stack of trays and placing the tray in a release location, the method comprising:
positioning a top tray of the stack of trays in a tray removal position using a tray delivery mechanism;
removing the top tray of the stack of trays from the tray removal position using a tray removal mechanism;
moving the top tray from the tray removal position to the tray release location using the tray removal mechanism;
releasing the top tray in the tray release location;
returning the tray removal mechanism to the tray removal position; and
repeating the process to remove the next tray of the stack of trays.

32. The method of claim 31, wherein the tray delivery mechanism comprises a tray delivery motor, a tray drive mechanism and a tray guide rail, the stack of trays being located on the tray drive mechanism, and positioning a top tray of the stack of trays in the tray removal position comprises:
using the tray delivery motor to advance the tray drive mechanism;
advancing the stack of trays on the tray drive mechanism along the tray guide rail until the top tray of the stack of trays reaches the tray removal position; and
ceasing advancement of the tray drive mechanism while the top tray of the stack of trays is in the tray removal position.

33. The method of claim 31, further comprising:
sensing the presence of a tray in the tray removal position; and
waiting until a tray is sensed in the tray removal position before returning the tray removal mechanism to the tray removal position.

34. The method of claim 31, wherein the tray removal mechanism comprises a suction cup assembly and a pressure system; and
removing the top tray of the stack of trays from the tray removal position comprises generating a low pressure region in the suction cup assembly using the pressure system; and removing the top tray from the tray removal position using the suction cup assembly;
moving the top tray from the tray removal position to the tray release location comprises moving the suction cup assembly while maintaining the low pressure region in the suction cup assembly; and
releasing the top tray in the tray release location comprises discontinuing the low pressure region in the suction cup assembly to release the tray from the suction cup assembly in the tray release location.
